(19) United States
(12) Patent Application Publication
(10) Pub. No.: US 2017/0160411 A1
(43) Pub. Date: Jun. 8, 2017

(54) SEISMIC SENSOR MODULE

(71) Applicant: Schlumberger Technology Corporation, Sugar Land, TX (US)

(72) Inventors: Daniel Golparian, Kanagawa-ken (JP); Motohiro Nakanouchi, Hachioji-Shi (JP); Toshio Suzuki, Hachio-ji-shi (JP)

(21) Appl. No.: 15/367,246

(22) Filed: Dec. 2, 2016

Related U.S. Application Data
(60) Provisional application No. 62/264,258, filed on Dec. 7, 2015.

(51) Int. Cl. G01V 1/16; G01V 1/40

(52) U.S. Cl. CPC G01V 1/168; G01V 1/40; G01V 2210/1429

(57) ABSTRACT

An apparatus that is usable with a well includes a cable, a sensor module that contains seismic sensors, and a bulkhead connection. The bulkhead connection connects the cable to the sensor module at a radial offset with respect to the longitudinal axis of the cable.

### RELATED APPLICATIONS

This application claims the benefit of a related U.S. Provisional Application Ser. No. 62/264,258, filed Dec. 7, 2015, entitled “SEISMIC SENSOR MODULE,” to Daniel GOLPARIAN et al., the disclosure of which is incorporated by reference herein in its entirety.

### BACKGROUND

Downhole tools may be deployed in a wellbore that traverses a hydrocarbon bearing geologic structure for a variety of purposes; and these tools may communicate with the Earth surface via a telemetry system. For example, the tools may include receivers, or sensors, which acquire measurements of various well-related parameters. In this manner, pressure sensors, temperature sensors, strain sensors, seismic receivers, electromagnetic (EM) sensors, resistivity sensors and so forth may be deployed in the well for purposes of acquiring information about the environment inside the well, the properties of the geologic structure, conditions and parameters of downhole equipment, and so forth.

### SUMMARY

In accordance with an example implementation, an apparatus that is usable with a well includes a cable, a sensor module that contains seismic sensors, and a bulkhead connection. The bulkhead connection connects the cable to the sensor module at a radial offset with respect to the longitudinal axis of the cable.

In accordance with another example implementation, a technique that is usable with a well includes providing a sensor deployment cable, where the cable includes a plurality of bulkhead connectors at different axial positions along the cable; and selectively connecting sensor modules to the bulkhead connectors to form a predetermined sensor configuration. Connecting a sensor module of the sensor modules includes connecting the module to the side of the cable so that module is radially offset with respect to an axis of the cable. The technique includes deploying the sensor deployment cable into the well to record seismic activity in connection with a seismic acquisition.

In accordance with yet another example implementation, an apparatus includes a housing, a seismic sensor circuit and a bulkhead connector. The housing includes a chamber, and the seismic sensor circuit is disposed in the chamber. The seismic sensor circuit is associated with a plurality of signals, and the plurality of signals include at least one input signal that is received by the seismic circuit and at least one output signal that is transmitted by the seismic circuit. The bulkhead connector connects the sensor module to a bulkhead connector. The signals are routed through the bulkhead connector.

Advantages and other desired features will become apparent from the following drawings, description and claims.

### BRIEF DESCRIPTION OF THE DRAWINGS

FIG. 1 is a schematic diagram of a well having a cable-based seismic acquisition or system according to an example implementation.

FIGS. 2A and 2B are schematic diagrams illustrating the connection/disconnection of a seismic sensor module to/from a sensor deployment cable according to an example implementation.

FIG. 2C illustrates a bulkhead connection for the seismic sensor module according to an example implementation.

FIG. 3 is a cross-sectional view taken along line 3-3 of FIG. 2A according to an example implementation.

FIG. 4 is a cross-sectional view of an encapsulated sensor circuit assembly according to an example implementation.

FIG. 5 is flow diagram depicting a technique to perform a seismic acquisition in a well according to an example implementation.

### DETAILED DESCRIPTION

Systems and techniques are described herein for purposes of deploying seismic receivers, or sensors, downhole in a well in a manner that allows a relatively high sensor density, permits selective grouping of the sensors to correspond to different regions of the well and allows a relatively flexible manner of connecting and disconnecting the sensors to/from a sensor deployment cable. A seismic sensor module may contain multiple seismic sensors. For example, the seismic sensor module may contain a hydrophone or pressure sensor, as well as one or multiple particle motion sensors (three accelerometers, which are oriented along different sensing axes, for example).

In accordance with example implementations, a single bulkhead connection is used for purposes of connecting the sensor module to a sensor deployment cable. In this manner, as described herein, the single bulkhead connection allows a given seismic sensor module to be installed on the side of the sensor deployment cable at a position that is radially offset with respect to the longitudinal axis of the cable. Sensor and power signals for the seismic sensor module may be routed through the single bulkhead connection.

Due to the use of a single bulkhead connection, the overall length of the sensor module may be reduced, as compared to conventional cable-based sensor tools. In this manner, conventionally, a sensor deployment cable may be constructed by serially connecting seismic sensor tools (each tool contains multiple seismic sensors, for example) and cable segments together. For this conventional cable, a given sensor tool may contain two bulkhead connectors: a first bulkhead connector to connect the sensor tool to a cable segment above the sensor tool and a second bulkhead connector to connect the sensor tool to a cable segment below the tool. Due to the multiple bulkhead connectors, a sensor tool with such a design, has a relatively long length, as compared to, for example, the cable-based seismic sensor module that is described herein, which has a single bulkhead connection. Thus, in accordance with example implementations that are described herein, input signals that are being received by the circuitry of the seismic sensor module, signals that are being generated by the circuitry, and power may be all routed through the same, single bulkhead connection, thereby allowing the sensor module to have a relatively small size.

Because the seismic sensor modules are mounted to the side of the seismic deployment cable, the seismic sensor modules may be selectively mounted to/removed from the cable during the deployment of the seismic acquisition system downhole, thereby allowing make-up of a particular seismic sensor configuration at the time of deployment. In this manner, the sensor modules may be spatially distributed on the sensor deployment cable during deployment to create sensor groups that target corresponding downhole regions. Moreover, defective sensor modules may readily be removed and replaced.

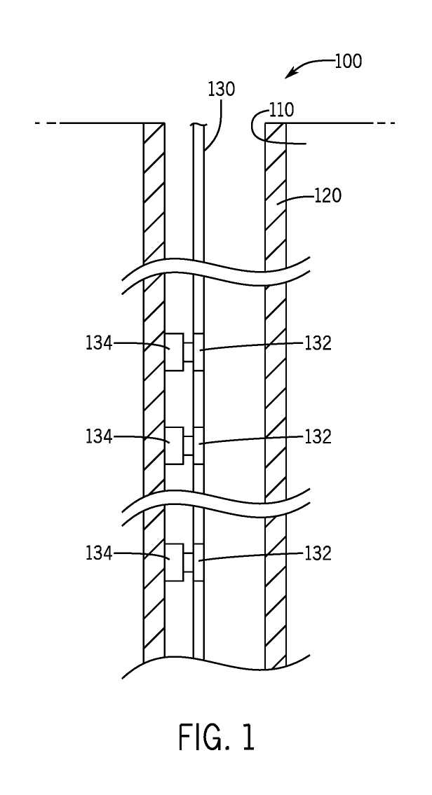

As a more specific example, FIG. 1 depicts a well 100 in accordance with some implementations. As depicted in FIG. 1, a sensor deployment cable 130 may extend into a wellbore 110 (a lateral, vertical, or deviated wellbore, for example) of the well 100. The sensor deployment cable 130 is part of a wellbore-based seismic acquisition to survey a particular geologic structure that is traversed by the wellbore 110. The sensor deployment cable 130 contains sensors that sense reflected and direct energy provided by one or more Earth surface or wellbore-disposed seismic sources (not shown) of the seismic acquisition system.

In addition to the seismic sensors, the sensor deployment cable 130 contains various “backbone” components, for purposes of communicating and powering the sensors. For example, these backbone components may include one or multiple optical fibers and possibly one or multiple optical repeaters that form an optical telemetry backbone. Moreover, the backbone components of the sensor deployment cable 130 may include copper wiring for purposes of communicating power to the sensors, as well as copper wire for communicating telemetry signals to and from sensors. Depending on the particular implementation, the backbone components may include optical repeaters, optical-to-copper couplers, copper lines, optical fibers, and so forth.

In general, sensor deployment cable 130 may communicate downlink data (command data, for example) from equipment at the Earth surface (not shown) to the sensor modules. Moreover, the sensor deployment cable 130 may communicate uplink data (acquired seismic data, for example) the sensor modules 134 to the circuitry at the Earth surface.

As depicted in FIG. 1, in accordance with example implementations, the sensor deployment cable 130 may extend inside a tubing string 120. In some implementations, the tubing string 120 may be a casing string, which lines and supports the wellbore 120 and may be cemented in place. In accordance with further example implementations, the tubing string 120 may extend into an open completion and may be held in place by isolation devices or annulus packers. Thus, many implementations are contemplated, which are within the scope of the appended claims.

The seismic sensors are contained with sensor modules 134. A given sensor module 134 may include one or multiple sensors, depending on the particular implementation. In this manner, the sensor module 130 may include a wide variety of devices such as pressure sensors; temperature sensors; strain sensors; resistivity sensors; fluid samplers; formation samplers; nuclear magnetic resonance (NMR) sensors; electromagnetic field (EMF) sensors; particle motion sensors (or geophones); pressure sensors (or hydrophones); one or multiple microelectromechanical system (MEMS)-based sensors; a combination of one or more of the foregoing devices; and so forth.

In accordance with example implementations, the sensor deployment cable 130 may include bulkhead connectors 132, which mechanically and operatively couple the sensor modules 134 to sensor deployment cable 130. The bulkhead connectors 132 may be spatially distributed along the length of the cable 130. In this manner, in accordance with some implementations, the bulkhead connectors 132 may be spaced apart at a regular axial spacing along the length of the sensor deployment cable 130. However, the bulkhead connectors 132 may be disposed in selected segments of the sensor deployment cable 130, in accordance with further example implementations.

In general, each bulkhead connector 132 provides fluid seal through which power and communication lines may extend between the sensor deployment cable 130 and the associated sensor module 134 for purposes of communicating power and telemetry signals between the cable 130 and the sensor module 134. As depicted in FIG. 1, in accordance with example implementations, the sensor module 134 may be attached, via the bulkhead connector 132, to the side of the sensor deployment cable 130 and accordingly, may be radially offset with respect to the longitudinal axis of the cable 130.

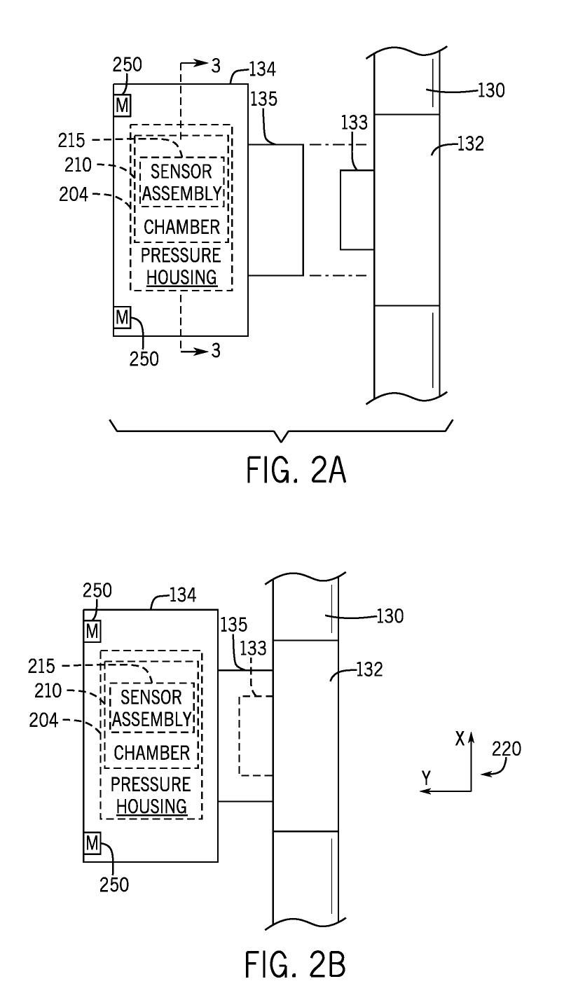

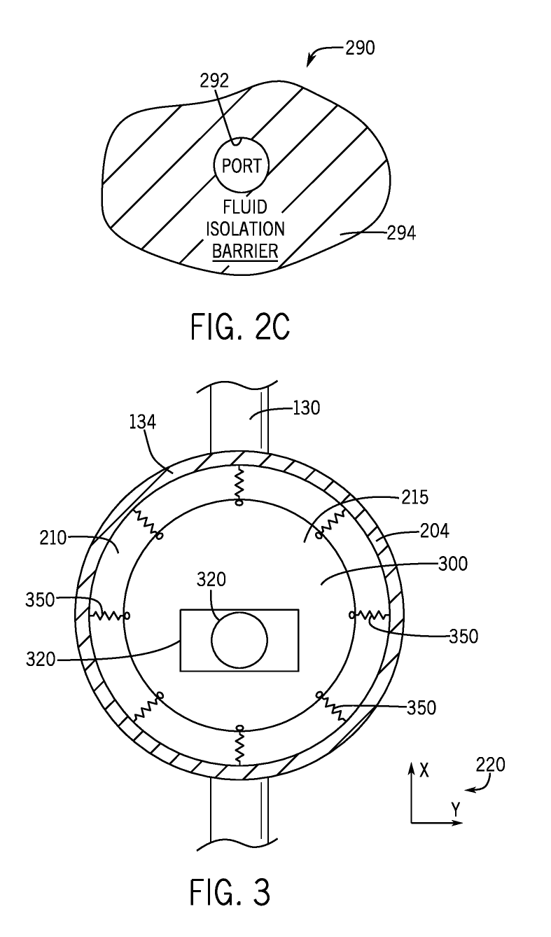

FIG. 2A generally depicts a given sensor module 134 in proximity to a bulkhead connector 132. In accordance with some implementations, the bulkhead 132 has a portion 133 that is adapted to mate, or engage, a mating portion 135 of the sensor module 134. Therefore, in accordance with some implementations, the mating of the portions 133 and 135 forms a corresponding bulkhead connection. In this context, a “bulkhead connection” refers to a sealed connection, containing one or multiple ports 292 (see FIG. 2C, depicting a single exemplary port 292). In this manner a fluid isolation barrier 294 is created about the port(s) 292 for purposes of forming a sealed path between the interior of the sensor module 134 and the interior of the sensor deployment cable 130. In accordance with some implementations, the portions 133 and 135 are connectors, which have corresponding conductive portions that are designed to align and couple to each other when the portions 133 and 135 mate. In this manner, electrical and/or optical signals may be communicated over these connectors when mated together.

FIG. 2B illustrates connection of the seismic sensor module 134 to the bulkhead connector 132. In accordance with example implementations, the seismic sensor module 134 includes a pressure housing 204 that contains the components of the seismic sensor module 134 within. For example, as depicted in FIG. 2B a sensor assembly 215 of the sensor module 134 may be disposed in a chamber 210 of the pressure housing 204.

More specifically, referring to FIG. 3, in accordance with some implementations, the sensor assembly 215 may include a circuit board assembly 300 in which various components of the sensor assembly 215 are mounted on a printed circuit board (PCB) substrate. For example, in accordance with example implementations, the sensor assembly 215 may include microelectromechanical system (MEMS) sensors 320 that may be mounted on the substrate of the circuit assembly 300 and sense particle motions (accelerations, for example) along different orthogonal sensing axes 220. Moreover, the circuit assembly 300 may also include additional circuits other than sensor circuits, such as circuits to receive signals representing commands transmitted from circuitry at the Earth surface and decode the commands, as well as circuits to generate signals indicating status information that is communicated to the circuitry at Earth surface.

In accordance with example implementations, the circuit assembly 300 is mounted inside the chamber 210 of the pressure housing 204 on a suspension mount. As depicted in FIG. 3, in accordance with example implementations, the suspension mount may be formed from multiple springs 350, where each spring 350 has one end that is connected to the pressure housing 204 and another end that is connected to the assembly 300. As depicted in FIG. 3, in accordance with some implementations, the springs 350 may be coiled-type springs, although other springs may be used, in accordance with further implementations. In general, the spring 350 is formed from a relatively rigid, but sufficiently flexible material that allows the mechanical decoupling of the sensors of the sensor module 134 (such as the MEMS sensors 320, for example) from the seismic deployment cable 130.

In accordance with some implementations, the springs 350 may be constructed from an electrically conductive material, which serves dual purposes: mounting the circuit assembly 300 to the pressure housing 204 to mechanically decouple the sensors from the cable 130; and communicating telemetry and/or power signals between the circuit assembly 300 and corresponding communication line/power lines of the sensor deployment cable 130. More specifically, in accordance with some implementations, each spring 350 may communicate a different input/output (I/O) or power signal for the circuit assembly 300.

For example, in accordance with some implementations, for a point-to-point duplex system that uses twisted pair cables, four pairs of signals may be used to communicate signals for a pressure sensor and three accelerometers. As a result, eight springs 350 (two for each sensor) may be used to communicate the corresponding eight signals between the circuit assembly 300 and the sensor deployment cable 130. In accordance with some implementations, power for the circuit assembly 300 may be communicated over one or more of the same springs 350 and may be multiplexed onto the same spring 350 with, for example, a corresponding sensor signal. Thus, many implementations are contemplated, which are within the scope of the appended claims.

In accordance with some implementations, the pressure housing 204 may be a high temperature housing. In accordance with further example implementations, in lieu of the pressure housing 204 being a high temperature housing, a dielectric fluid, such as silicon oil, may be filled inside the chamber 210 to surround the circuit assembly 300. Pressure sensitive devices of the circuit assembly 300, such as oscillators containing cavities, may be constructed to comply with the surrounding dielectric fluid. Moreover, referring to FIG. 4 in conjunction with FIG. 3, in accordance with some implementations, the circuit assembly 300 may be encapsulated with an encapsulant 400 (an epoxy-based material, for example) for purposes of avoiding or preventing contamination and/or corrosion of components of the circuit assembly 300. In accordance with some implementations, the pressure housing 204 may have a removable cover (not shown), which may contain a port to allow filling of the chamber 210 with the dielectric fluid.

Referring to FIG. 2B, among its other features, in accordance with some implementations, the seismic module 134 may contain one or multiple devices to mechanically or physically couple the module 134 to the surrounding tubing string 120 see FIG. 1). More specifically, in accordance with some implementations, one or multiple magnets 250 may be disposed at various points of the module 134 for purposes of magnetically adhering the module 134 to the wall of the surrounding tubing string.

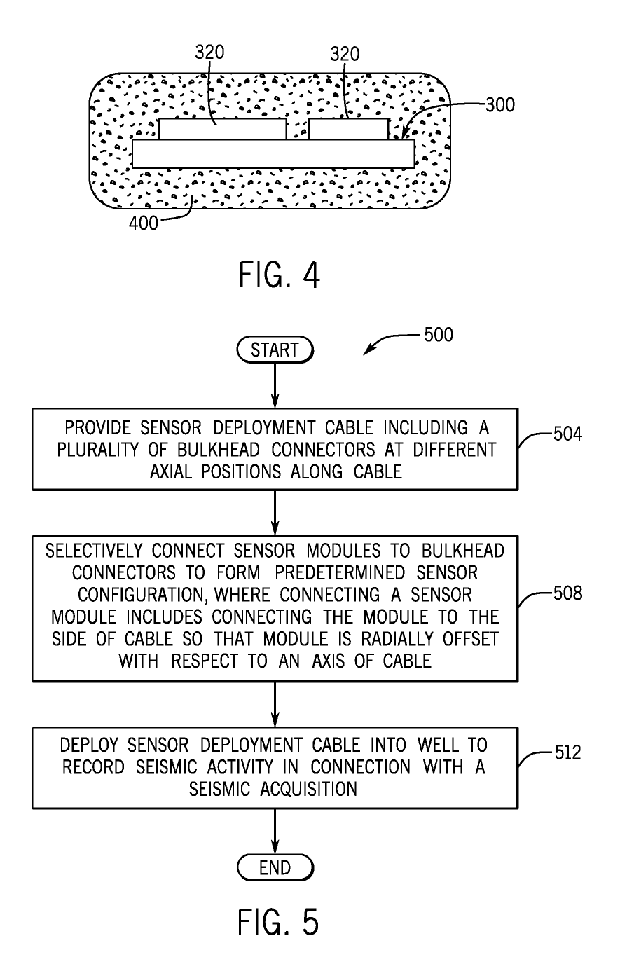

Thus, referring to FIG. 5, in accordance with example implementations, a technique 500 includes providing (block 504) a sensor deployment cable that includes a plurality of bulkhead connectors at different axial positions along the cable and selectively connecting (block 508) sensor modules to the bulkhead connectors to form a predetermined sensor configuration. Connecting the sensor module(s) includes connecting each module to the side of the sensor deployment cable so that the module is radially offset with respect to an axis of the cable. The technique 500 includes deploying (block 512) the sensor deployment cable into the well to record seismic activity in connection with a seismic acquisition, or survey, of a geologic structure.

While the present techniques have been described with respect to a number of embodiments, it will be appreciated that numerous modifications and variations may be applicable therefrom. It is intended that the appended claims cover all such modifications and variations as fall within the scope of the present techniques.

What is claimed is:

1. An apparatus usable with a well, comprising:
a cable having a longitudinal axis;
a sensor module comprising seismic sensors; and
a bulkhead connection to connect the cable to the sensor module at a radial offset with respect to the longitudinal axis of the cable.

2. The apparatus of claim 1, wherein the sensor module comprises wires associated with signals transmitted by and signals received by electrical components of the sensor module, and the wires are electrically coupled to wires of the cable using the bulkhead connection.

3. The apparatus of claim 1, wherein the sensor module comprises:
a circuit assembly comprising sensor circuits;
a housing comprising a chamber; and
a plurality of springs connected the housing and the circuit assembly to suspend the circuit assembly in the chamber.

4. The apparatus of claim 3, wherein the springs communicate signals between the circuit assembly and the bulkhead connection.

5. The apparatus of claim 3, wherein the springs communicate electrical power to the circuit assembly from the cable.

6. The apparatus of claim 1, wherein the sensor module comprises:
a circuit assembly comprising sensor circuits;
a housing comprising a chamber; and
a dielectric fluid in the chamber.

7. The apparatus of claim 6, further comprising an encapsulation to surround the circuit assembly.

8. The apparatus of claim 1, wherein the sensors comprise accelerometers.

9. The apparatus of claim 1, wherein the cable comprises at least one of power lines and fiber optic lines passing through the cable and not passing through the bulkhead connection.

10. The apparatus of claim 1, further comprising at least one magnet to couple the sensor module to a downhole tubing string.

11. A method usable with a well, comprising:
providing a sensor deployment cable comprising a plurality of bulkhead connectors at different axial positions along the cable; and
selectively connecting sensor modules to the bulkhead connectors to form a predetermined sensor configuration, wherein connecting a sensor module of the sensor modules comprises connecting the module to the side of the cable so that module is radially offset with respect to an axis of the cable; and
deploying the sensor deployment cable into the well to record seismic activity in connection with a seismic acquisition.

12. The method of claim 11, wherein connecting at least one of the sensor modules comprises routing all wires associated with the sensor module through a single bulkhead connection between the sensor module and the cable.

13. The method of claim 11, further comprising mechanically decoupling sensors of the sensor modules from the cable.

14. The method of claim 13, wherein mechanically decoupling the sensors comprises, for at least one of the sensor units, mounting sensors of the sensor unit to a housing of the sensor unit using springs.

15. The method of claim 14, further comprising communicating at least one of power and signals for the at least one sensor unit using the springs as electrical conductors.

16. An apparatus comprising:
a housing comprising a chamber;
a seismic sensor circuit disposed in the chamber, wherein the seismic sensor circuit is associated with a plurality of signals, and the plurality of signals comprise at least one input signal received by the seismic circuit and at least one output signal transmitted by the seismic circuit; and
a bulkhead connector to connect the sensor module to a bulkhead connector, wherein the plurality of signals are routed through the bulkhead connector.

17. The apparatus of claim 16, further comprising a dielectric fluid in the chamber.

18. The apparatus of claim 16, further comprising a suspension mounting coupled to the seismic sensor circuit and the housing to suspend the circuit inside the chamber.

19. The apparatus of claim 18, wherein the suspension mounting comprises suspension elements to communicate signals with the seismic sensor circuit.

20. The apparatus of claim 16, wherein the seismic sensor circuit comprises
microelectromechanical system (MEMS) sensors.
